(19) United States
(12) Patent Application Publication
(10) Pub. No.: US 2016/0208930 A1
(43) Pub. Date: Jul. 21, 2016

(54) VALVE FOR SHUTTING OFF AND/OR CONTROLLING THE FLOW RATE OF FLUID FLOWS, AND A METHOD FOR THE POST-PRODUCTION OF SUCH A VALVE

(71) Applicant: SIEMENS AKTIENGESELLSCHAFT, München (DE)

(72) Inventors: RALF BELL, MÜLHEIM AN DER RUHR (DE); ISABELL BÖER, MÜLHEIM AN DER RUHR (DE); THOMAS FISCHER, MÜLHEIM AN DER RUHR (DE); GIUSEPPE GAIO, BONN (DE); RAIMUND HEINZE, OBERHAUSEN (DE); MARKUS LEGENBAUER, ESSEN (DE); DAMIAN RAZOWSKI, MÜLHEIM AN DER RUHR (DE); THOMAS RIEDEL, MÜLHEIM AN DER RUHR (DE); STANISLAW RUDA, MOERS (DE); RALF ZIWES, DINSLAKEN (DE)

(21) Appl. No.: 14/915,286

(22) PCT Filed: Sep. 23, 2014
(86) PCT No.: PCT/EP2014/070217

§ 371 Date: Feb. 29, 2016

(30) Foreign Application Priority Data
Sep. 24, 2013 (EP) 13185752.6

(51) Int. Cl. F16K 1/42; F01K 13/02; F16K 25/00

(52) U.S. Cl. CPC F16K 1/42; F16K 25/005; F01K 13/02

(57) ABSTRACT

A valve for shutting off and/or controlling the throughflow of fluid flows is provided. A valve housing, having a valve seat contact surface, a valve cover with a valve cover thickness which is provided with a material allowance, and the valve body form together a first, maximum lift; and when the worn region of the valve seat contact surface is removed, the valve cover thickness can be removed such that the first, maximum lift remains the same or remains the same with only minor deviations; and/or the valve housing, valve seat contact surface, valve cover with the valve cover thickness, and the valve body is provided with a material allowance form a first, particularly maximum lift; and when the worn region of the valve seat contact surface is removed, the valve body can be removed such that the first, maximum lift remains the same or with only minor deviations.

### CROSS-REFERENCE TO RELATED APPLICATIONS

This application claims priority to PCT Application No. PCT/EP2014/070217, having a filing date of Sep. 23, 2014, based off of EP Application No. 13185752.6 having a filing date of Sep. 24, 2013, the entire contents of which are hereby incorporated by reference.

### FIELD OF TECHNOLOGY

The following relates to a valve for shutting off and/or controlling the throughflow of fluid flows, comprising a valve casing, a valve diffuser arranged in the valve casing and having a valve seat contact surface, and a valve body that is arranged so as to be able to move in the valve casing, wherein the valve body and the valve seat contact surface are in contact with one another at least when shutting off the throughflow of fluid flows. The following further relates to a method for reworking such a valve.

### BACKGROUND

Modem steam turbines experience high steam mass flows, in particular with low fresh steam parameters. In order to control these large steam mass flows, use is made of individual control valves which are positioned directly on or next to the turbine. The quantity of steam is controlled by means of a valve seat contact surface and a valve piston, e.g. a valve body, of a control valve. The control valves are controlled directly by means of dedicated actuating cylinders and can thus be opened individually according to the operating conditions of the turbine, such that the desired steam mass flow can be set. However, under extreme conditions, such as high steam pressure and high thermal stresses, wear and fatigue can impair the reliability and the service life of the valve. Valve components are subjected to frequent opening and closing cycles, high impact forces and significant steam pressure during cold, warm or hot start-up of a steam turbine.

These repeated loads accentuate the wear and the fatigue of the valves. Consequences of fatigue and wear of steam turbine valves include leaks, the inability to open the valve, and inadequate sealing of the steam path. Such valves generally comprise a valve casing and a valve diffuser which is arranged inside the valve casing and through which flows incoming steam. The mass flow is set with the aid of a valve body which is designed so as to be able to move in the direction of the valve diffuser. In the fully closed position, the valve body bears against a valve seat contact surface that is connected to the valve diffuser. In an open position, there is formed between the valve body and the valve seat contact surface a throughflow area which is correlated directly with the mass flow through the valve.

In the closed state, the valve body bears against the valve seat contact surface and forms a contact surface. This contact surface is subject to greater load due to the impacts of the valve body during closing. This region is therefore subject to wear phenomena due to steam erosion and also to wear phenomena due to mechanical loads. In order to counteract such mechanical loads, the contact surface on the valve seat contact surface is generally plated, which is for example achieved by stelliting. However, despite the plating, after relatively long operation it is often necessary to refurbish the surface of the valve seat on account of solid state erosion and steam erosion.

The replacement of the entire valve seat would be one possible way of preventing further damage, but the replacement is made more difficult since assembly work on the turbine is generally associated with increased complexity.

It is similarly conceivable to counteract the wear arising from erosion by virtue of an appropriate material selection. Materials of this type are, however, comparatively expensive and damage nevertheless generally arises on the valve seat contact surface after a certain operating time. If it is not possible to refurbish a damaged surface of this kind, the valve seat contact surface is dismantled and replaced with a new one. In the event of overhauls and during stoppages, the valves are examined and it may be the case that a decision is made on site as to which measure is required to restore the operation of the valve. Either refurbishment or complete valve replacement is required. Tests such as, for example, a dye penetrant test or an ultrasonic test are required for sufficiently good analysis. If a measure is to be taken, there is an appreciable, sometimes extended idle time between when the decision is made and when the measure is carried out.

### SUMMARY

An aspect relates to an improved valve which avoids the abovementioned problems. Another, second aspect is that of specifying a method for reworking such a valve.

According to embodiments of the invention, the first aspect is achieved by specifying a valve for shutting off and/or controlling the throughflow of fluid flows, comprising a valve casing, a valve diffuser arranged in the valve casing and having a valve seat contact surface, and a valve body that is arranged so as to be able to move in the valve casing, wherein the valve body and the valve seat contact surface are in contact with one another at least when shutting off the throughflow of fluid flows, and wherein the valve body additionally has a valve bonnet with a valve bonnet thickness. According to embodiments of the invention, the valve seat contact surface is made of a reinforcing alloy, in particular a chromium-based alloy, wherein in operation the valve seat contact surface is subject to wear, such that at least one worn region results, and wherein the valve casing, the valve seat contact surface, the valve bonnet with the valve bonnet thickness, which is provided with an additional thickness of material, and the valve body together form a first, in particular maximum travel and, when the worn region of the valve seat contact surface is machined, the valve bonnet thickness can be machined such that the first, in particular maximum travel remains the same or remains the same within only minor deviations and/or the valve casing, the valve seat contact surface, the valve bonnet with the valve bonnet thickness and the valve body, which is provided with an additional thickness of material, together form a first, in particular maximum travel and, when the worn region of the valve seat contact surface is machined, the valve body can be machined such that the first, in particular maximum travel remains the same or remains the same within only minor deviations.

According to embodiments of the invention, the second aspect is achieved by specifying a method for reworking a valve having a valve body and having a valve seat contact surface that is made of a reinforcing alloy, in particular a chromium-based alloy, and wherein the valve body additionally has a valve bonnet with a valve bonnet thickness, which is provided with an additional thickness of material, consists as claimed in one of the above claims, wherein the valve seat contact surface is worn during operation, resulting in at least one worn region, and wherein at least the worn region of the valve seat contact surface is machined and wherein the valve body additionally has a valve bonnet with a valve bonnet thickness, with which the valve body is attached to a valve casing, and wherein the valve casing, the valve seat contact surface, the valve bonnet with the valve bonnet thickness and the valve body together form a first, in particular maximum travel and, when the worn region of the valve seat contact surface is machined, the valve bonnet thickness is machined such that the first, in particular maximum travel remains the same or remains at least approximately the same and/or the valve body additionally has a valve bonnet with a valve bonnet thickness, with which the valve body is attached to a valve casing, and wherein the valve casing, the valve seat contact surface, the valve bonnet with the valve bonnet thickness and the valve body, which is provided with an additional thickness of material, together form a first, in particular maximum travel and, when the worn region of the valve seat contact surface is machined, the valve body is machined such that the first, in particular maximum travel remains the same or remains at least approximately the same.

It is thus proposed, according to embodiments of the invention, to develop a valve such that the latter has a valve seat contact surface which is made of a reinforcing alloy and which is in contact with the valve body. That means that the valve is now provided with a valve seat contact surface made of the reinforced material (e.g. stellite). This valve seat contact surface is shaped such that the region of the contact surface, when new, is provided with an additional thickness of material. The additional thickness of material is machined during an overhaul. The removal of material can be carried out during multiple overhauls. Therefore, this valve seat contact surface can be touched up after each overhaul irrespective of findings, i.e. the worn region of the valve seat contact surface can be machined after each overhaul irrespective of findings. This saves a lot of time, since tests are not considered necessary a priori. This reduces the downtimes of such a valve. Advantageously, therefore, complete replacement of the diffuser or of the valve seat is not necessary. It is also not necessary to remove the entire valve from the turbine. This also reduces the downtimes of such a valve.

A particular advantage lies in the fact that an overhaul can be better planned in advance and carried out since the machining of the worn region of the valve seat contact surface can always take place irrespective of findings. As a result, dye penetrant tests and ultrasonic tests can be dispensed with entirely. It is not necessary to carry out a refurbishment which is complex, costly and hazardous to health.

Preferably, the valve body additionally has a valve bonnet with a valve bonnet thickness. In one advantageous configuration, the valve bonnet is embodied as a flange. Advantageously, the valve bonnet thickness of the valve bonnet can be reduced. This can for example be achieved by grinding.

The valve casing, the valve seat contact surface, the valve bonnet with a valve bonnet thickness and the valve body together form a first, in particular maximum travel, wherein, when the worn region of the valve seat contact surface is machined, the valve bonnet thickness can be machined such that the first, in particular maximum travel remains the same or remains at least approximately the same. It is also possible that the valve casing, the valve seat contact surface, the valve bonnet with a valve bonnet thickness and the valve body together form a first, in particular maximum travel, and wherein, when the worn region of the valve seat contact surface is machined, the valve body can be machined such that the first, in particular maximum travel remains the same or remains at least approximately the same.

This means that, simultaneously after each removal of material, the position of the valve bonnet can be readjusted as required in order to match the travel of the valve to the reworked contour of the valve seat. This is effected for example by machining the valve bonnet, of which the valve bonnet thickness (i.e. the wall thickness of the valve bonnet) is accordingly thicker when new. Alternatively or in addition to reworking the valve bonnet, the removal of material for adapting the travel can also be carried out on the valve body. The flow through the valve thus remains the same, i.e. the flow coefficient remains the same. This ensures, for example, safe operation of the plant in which the valve is used. Preferably, the valve seat contact surface is made of a cobalt-chromium-based alloy. In particular, the valve seat contact surface is made of stellite. This is particularly suitable, by virtue of its high resistance to wear and to elevated temperatures, for use in power plants.

Preferably, the valve seat contact surface is configured as a replaceable bushing. After a maximum number of reworkings, it is no longer possible to remove material. In this case, the bushing is then replaced and the valve bonnet is adapted accordingly, such that it is once again possible to readjust the travel. Thus, therefore, complete replacement of the diffuser or of the valve seat is not necessary here either. It is also not necessary to remove the entire valve from the turbine. This reduces the downtimes of such a valve. The valve body can e.g. in general be provided with only a relatively thin plating. By contrast, a bushing can be made entirely of a reinforcing alloy and thus makes it possible for the contour to be reworked without entirely removing an applied plating, as would be the case for the valve body.

In one preferred configuration, the valve is provided in a plant and the reworking is carried out during an overhaul of the plant.

### BRIEF DESCRIPTION

Some of the embodiments will be described in detail, with reference to the following figures, wherein like designations denote like members, wherein:

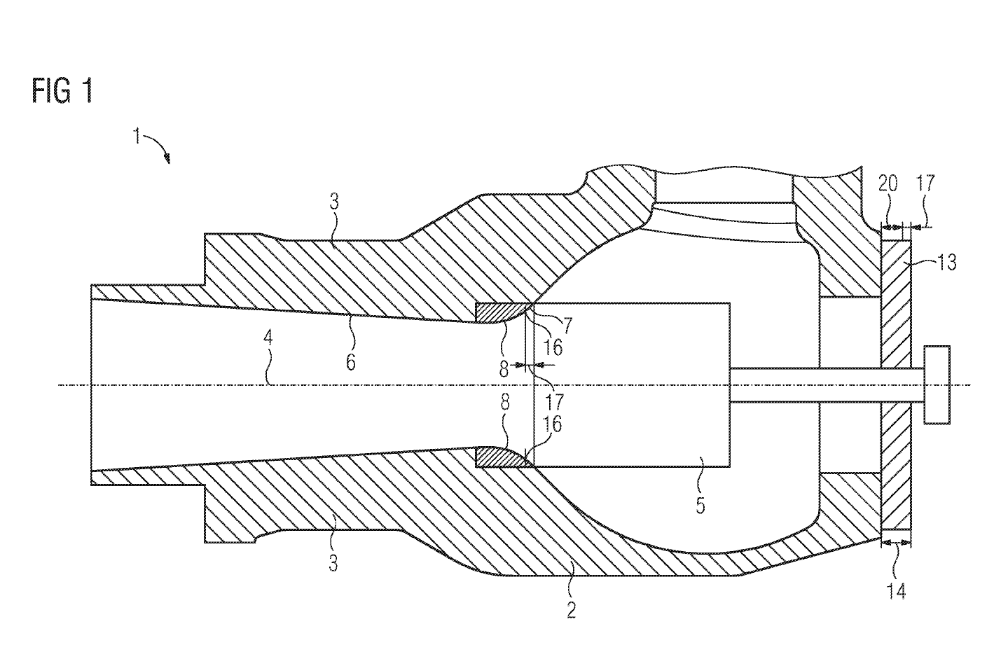

FIG. 1 shows a cross section view of a first exemplary embodiment of a valve; and

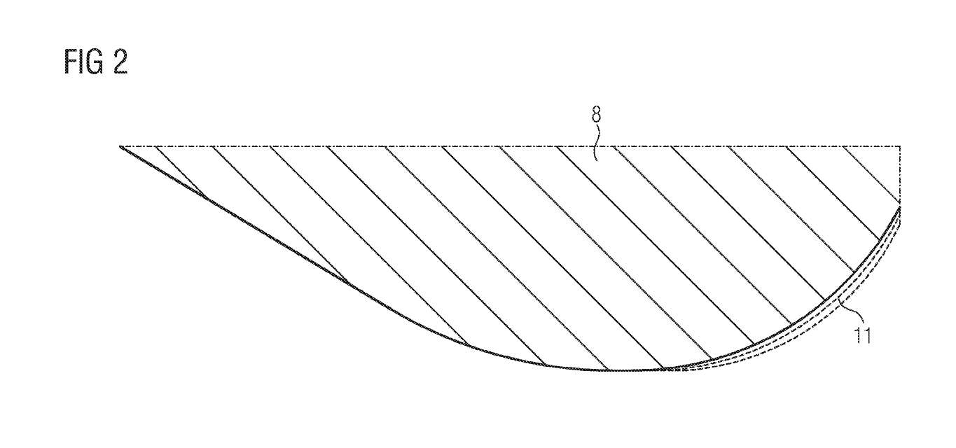

FIG. 2 shows a detail of a valve seat contact surface when new.

FIG. 1 shows a cross section view of a valve 1 according to embodiments of the invention. The valve 1 comprises a valve casing 2 and, inside the valve casing 2, an essentially axisymmetric valve diffuser 3. FIG. 1 depicts an axis of symmetry 4. The valve diffuser 3 is essentially axisymmetric with respect to this axis of symmetry 4. A conical inner shell region 6, through which a steam flows at a comparatively high temperature and high pressure during operation, is formed within the valve diffuser 3. At the start 7 of the valve diffuser, the valve diffuser 3 is fixedly arranged on the casing 2. The valve diffuser 3 comprises a valve seat contact surface 8 which is arranged on the start 7 of the valve diffuser and is designed to make contact with a valve body 5. The valve body 5 and the valve seat contact surface 8 are in contact with one another, at least when the throughflow of fluid flows is shut off The valve seat contact surface 8 is now made of a reinforcing alloy, in particular a chromium-based alloy, wherein in operation the valve seat contact surface 8 is subject to wear, such that at least one worn region results. During an overhaul, at least the worn region of the valve seat contact surface 8 is now machined. In that context, the valve seat contact surface 8 is embodied such that machining is possible. That means that, when new, an additional thickness of material is provided, this being shown in FIG. 2. It is thus possible for the worn regions to be machined during multiple overhauls. It is thus no longer necessary to replace the valve or the valve diffuser 3 quite so often.

The valve body 5 additionally has a valve bonnet 13 with a valve bonnet thickness 14. The valve bonnet 13 allows the valve body 5 to be attached to the valve casing 2. In that context, the valve bonnet 13 can be embodied as a flange. That makes it simple for the valve bonnet thickness 14 of the valve bonnet 13 to be reduced, i.e. machined.

The valve casing 2, the valve seat contact surface 8, the valve bonnet 13 with a valve bonnet thickness 14 and the valve body 5 together form a first, in particular maximum travel. When the worn region of the valve seat contact surface 8 is machined, the valve bonnet thickness 14 can be machined such that this first, in particular maximum travel remains the same or remains at least approximately the same. That means that, if the worn region is for example machined to a point 16 by an amount 17, the valve bonnet 13 is also reduced by an amount 17, to give a wall thickness 20. Thus, the first, in particular maximum travel remains the same or approximately the same. In that context, the valve bonnet thickness 14 can be reduced by machining. The valve bonnet thickness 14 of the valve bonnet 13 is therefore accordingly thicker when new. The valve bonnet 13 can for example be ground down.

This means that, at the same time after each removal of material, in the case of the valve seat contact surface 8 the position of the valve bonnet 13 is readjusted as required in order to match the travel of the valve 1 to the reworked contour.

Alternatively or additionally, it is also possible for the valve body 5 to be reduced at another location, for example directly in the case of the contact surface with the valve seat contact surface 8, in order to restore the first, in particular maximum travel.

It is also possible for the valve seat contact surface 8 to be a cobalt-chromium-based alloy, in particular a stellite.

Alternatively, at least the valve seat contact surface 8 is configured as a replaceable bushing (not shown). The bushing is now in contact with the valve body 5. After a maximum number of reworkings, it is no longer possible to remove material from the bushing. In this case, the bushing is then replaced and the valve bonnet 13 is adapted accordingly, such that it is once again possible to readjust the first, in particular maximum travel.

According to embodiments of the invention, machining of the valve seat contact surface 8 and of the valve bonnet 13, or the valve body 5, does not require removal of the entire valve from the turbine. According to embodiments of the invention, this makes it no longer necessary to replace a complete casing 2 and/or diffuser 3.

The overhaul can be better planned in advance since the machining always takes place irrespective of the findings. The valve seat contact surface 8 can therefore be touched up after each overhaul irrespective of findings. This saves a lot of time, since tests for the findings are not considered necessary a priori, and are thus dispensed with. It is not necessary to carry out a refurbishment which is complex, costly and hazardous to health.

If the valve seat contact surface 8 is a replaceable bushing, this can be replaced more simply and without long downtimes.

A known valve body can generally be provided with only a thin plating. By contrast, the valve seat contact surface 8 can be made entirely of a reinforced material and thus makes it possible for the contour to be reworked without entirely removing an applied plating, as would be the case for the prior art valve body.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A valve for shutting off and/or controlling the throughflow of fluid flows, comprising a valve casing, a valve diffuser arranged in the valve casing and having a valve seat contact surface, and a valve body that is arranged so as to be able to move in the valve casing, wherein the valve body and the valve seat contact surface are in contact with one another at least when shutting off the throughflow of fluid flows, and wherein the valve body additionally has a valve bonnet with a valve bonnet thickness comprising: the valve seat contact surface is made of a reinforcing alloy, wherein in operation the valve seat contact surface is subject to wear, such that at least one worn region results, and wherein the valve casing, the valve seat contact surface, the valve bonnet with the valve bonnet thickness, which is provided with an additional thickness of material, and the valve body together form a first, a maximum travel and in that, when the worn region of the valve seat contact surface is machined, the valve bonnet thickness can be machined such that the first, maximum travel remains the same or remains the same within only minor deviations and/or the valve casing, the valve seat contact surface, the valve bonnet with the valve bonnet thickness and the valve body, which is provided with an additional thickness of material, together form a first maximum travel and in that, when the worn region of the valve seat contact surface is machined, the valve body can be machined such that the first maximum travel remains the same or remains the same within only minor deviations.

2. The valve as claimed in claim 1, wherein the valve body additionally has a valve bonnet with a valve bonnet thickness.

3. The valve as claimed in claim 2, wherein the valve bonnet is embodied as a flange.

4. The valve as claimed in claim 2, wherein the valve bonnet thickness of the valve bonnet can be reduced.

5. The valve as claimed in claim 1, wherein the valve seat contact surface is made of a cobalt-based alloy.

6. The valve as claimed in claim 1, wherein the valve seat contact surface is a stellite.

7. The valve as claimed in claim 1, wherein the valve seat contact surface is configured as a replaceable bushing.

8. A method for reworking a valve having a valve body and having a valve seat contact surface that is made of a reinforcing alloy, and wherein the valve body additionally has a valve bonnet with a valve bonnet thickness, which is provided with an additional thickness of material, as claimed in one of the above claims, comprising: the valve seat contact surface which is worn during operation, resulting in at least one worn region, and wherein at least the worn region of the valve seat contact surface is machined and wherein the valve body additionally has a valve bonnet with a valve bonnet thickness, with which the valve body is attached to a valve casing, and wherein the valve casing, the valve seat contact surface, the valve bonnet with the valve bonnet thickness and the valve body together form a first maximum travel and in that, when the worn region of the valve seat contact surface is machined, the valve bonnet thickness is machined such that the first maximum travel remains the same or remains at least approximately the same and/or the valve body additionally has a valve bonnet with a valve bonnet thickness, with which the valve body is attached to a valve casing, and wherein the valve casing, the valve seat contact surface, the valve bonnet with the valve bonnet thickness and the valve body, which is provided with an additional thickness of material, together form a first, maximum travel and in that, when the worn region of the valve seat contact surface is machined, the valve body is machined such that the first maximum travel remains the same or remains at least approximately the same.

9. The method as claimed in claim 8, wherein the valve is provided in a plant and the reworking is carried out during an overhaul of the plant.

10. The valve as claimed in claim 1, wherein the valve seat contact surface is made of a chromium-based alloy.

11. The valve as claimed in claim 8, wherein the valve seat contact surface is made of a chromium-based alloy.
